(19) United States
(12) Patent Application Publication
(10) Pub. No.: US 2025/0298809 A1
(43) Pub. Date: Sep. 25, 2025

(54) SYSTEM AND A METHOD FOR ROUTING DATA TO A CONVERTER IN AN ENTERPRISE PERFORMANCE MANAGEMENT SYSTEM

(71) Applicant: HONEYWELL INTERNATIONAL INC., Charlotte, NC (US)

(72) Inventors: Ambika Khatri, Bengaluru (IN); Rod Stein, Edmonton (CA); Joseph Majewski, Huntington, NY (US); Norman Beekwilder, McKenney, VA (US); Jitendra Singh, Bangalore (IN); Sakthi Vinayagan, Bangalore (IN)

(21) Appl. No.: 18/613,136

(22) Filed: Mar. 22, 2024

(51) Int. Cl. G06F 16/25; G06F 16/23

(52) U.S. Cl. CPC G06F 16/258; G06F 16/2379; G06F 16/2246

(57) ABSTRACT

The present disclosure provides a system for routing data to the converter framework of an enterprise performance management (EPM) system. The EPM system includes a database module operatively connected to a repository that stores information of one or more registered user devices, and a set of rules corresponding to each registered device. The system further includes a data identification module which is operatively coupled to the database module. The data identification module is configured to receive data from one or more user devices and, thereafter, communicate with the database module to identify if the user device is a registered device or unregistered device. When the user device is a registered device, the data identification module routes the data to the converter framework according to the rules specified in the database module. When the user device is identified as an unregistered device based on a query to the database module, the data identification module is configured to determine the identity of the user device and data type of the received data, identify an appropriate converter from the converter framework, and route the data to the converter for data conversion. The database module communicates with the repository to add the newly identified user device to one or more registered entities and specify rules corresponding to added new user device. Further, the database module communicates with the repository to update the information relating to one or more registered user devices and any rules corresponding to said user devices.

### TECHNICAL FIELD

Embodiments of the present disclosure generally relate to enterprise performance management systems, and particularly, relate to a system and a method for routing data to a suitable converter for converting non-standard data into a standard format for data analytics.

### BACKGROUND

One of the benefits of an enterprise performance management (EPM) system is the consolidation of data from various enterprises or entities which are registered with the EPM system. The enterprise/entity implements the EPM system to obtain insights based on real-time data associated with the various devices connected to the system, so that it can equip various stakeholders to make efficient business decisions. The EPM system comprises knowledge graphs that include data related to the entities registered with the EPM system, the user devices associated with each entity, the data type associated with each user device, which come from different sources and are then connected and combined with the help of computer systems to create an integrated and connected enterprise. In order to make a robust EPM system, the knowledge graph needs to be enriched with the updated user device and data type information in real-time. Existing EPM systems fail to provide a real-time solution to enrich the knowledge graph of the EPM systems. They also have no mechanism to enrich the knowledge graph data with information relating to new user devices or data types, thereby limiting the information that is made available to the enterprise during any decision-making processes.

In various applications relating to current EPM systems, the system is required to receive and consume non-standard data, and data from unknown user devices for further processing. The EPM system receives the non-standard data which is sent over a network and converts it into a standardized format before the data is used for data analytics that can assist in any decision-making process for the business. There are, however, technical challenges and difficulties associated with configuring the system to receive and convert non-standard data that are acquired from various sources, Further, there are technical challenges and difficulties in processing data received from unknown user devices connected to an EPM system. Through applied effort, ingenuity, and innovation, the inventors have solved the above problem(s) by developing the solutions embodied in the present disclosure, the details of which are described further herein.

### SUMMARY OF THE INVENTION

In general, embodiments of the present disclosure herein provide efficient selection of a converter in an enterprise performance management system. Other implementations will be, or will become, apparent to one with skill in the art upon examination of the following figures and detailed description. It is intended that all such additional implementations be included within this description be within the scope of the disclosure and be protected within the scope of the following claims.

In one embodiment, the present disclosure provides a system for routing data to the converter framework of an enterprise performance management system. The EPM system according to the present disclosure includes a data identification module. The database identification module is further coupled to a database module and said database module is operatively coupled to a repository that stores information of one or more registered user devices, and a set of rules corresponding to each registered device. The data identification module is configured to receive data from one or more user devices and, thereafter, communicate with the database module to identify if the user device is a registered device or unregistered device. When the user device is a registered device, the data identification module routes the data to the converter framework according to the rules specified in the database module. In an embodiment, when the user device is identified as an unregistered device based on a query to the database module, the data identification module is configured to determine the identity of the user device and data type of the received data, identify an appropriate converter from the converter framework, and route the data to the converter for data conversion. In an embodiment, the database module adds the newly identified user device to the list of one or more registered entities and specifies rules corresponding to added device. In an embodiment, the database module communicates with the repository to update any new information relating to one or more registered user devices and any rules corresponding to said user devices. In an embodiment, the data identification module and the database module are operatively connected to a processor and memory.

In another aspect, the present disclosure provides a method for routing data to the converter framework of an enterprise performance management system. The method according to the present disclosure comprises receiving data from one or more user device. Upon receiving the data, the data identification module queries the database module to identify if the user device is a registered device or an unregistered device. The database module communicates with the repository to obtain this information and sends this information to the data identification module. The method further includes identifying, based on the specified rules received from the database module for a registered user device, a suitable converter for converting the non-standard data and routing the data to said converter. In another aspect, the method, upon determination that the user device is an unregistered device, further includes processing of data to identify the data type and identity of the user device, and thereafter routing the data to the correct converter based on data type determination. The method further includes updating the repository, via the database module, to add the unregistered user device to one or more entities registered with the repository and also, specify one or more rules corresponding to added new user device. In another aspect, the method, includes updating the repository, via the database module, to update information relating to a registered user device and the one or more rules corresponding to said registered user device.

In yet another embodiment, the present disclosure provides a computer program product comprising at least one non-transitory computer-readable storage medium having computer-readable program code portions stored therein executed by a processor, the computer-readable medium when executed, is configured to receive data from one or more user device and identify if the data user device is a registered device or an unregistered device. Further, the processor is configured to route the data to the converter framework according to the specified rules retrieved by the database module if the user device is a registered device. The processor, upon determination that the user device is an unregistered device, is further configured to process data to identify the data type and identity of the user device and route the data to the correct converter based on data type determination. Furthermore, the processor is configured to update the repository to add the unregistered user device to the one or more registered entities and specify one or more rules corresponding to the added user device. The processor is also configured to update the database module to update information on a registered user device and one or more rules corresponding to said user device.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of EPM system in which embodiments of the present disclosure may operate;

FIG. 2 illustrates an exemplary block diagram of a database module in accordance with an example embodiment of the present disclosure;

FIG. 3 illustrates an exemplary block diagram illustrating converter selection for registered devices with the EPM system according ton an embodiment of the present disclosure;

FIG. 4a illustrates an exemplary block diagram illustrating converter selection for un-registered devices with the EPM system according to one embodiment of the present disclosure;

FIG. 4b illustrates an exemplary block diagram illustrating converter selection for un-registered devices with the EPM system to another embodiment of the present disclosure;

FIG. 5 is a flowchart depicting an example process for routing data for registered devices in accordance with the embodiments of the present disclosure.

FIG. 6 is a flowchart depicting an example process for routing data for unregistered devices in accordance with the embodiments of the present disclosure.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

An enterprise performance management (EPM) system integrates business processes, human resources and project management within an enterprise or across the value chain network of an enterprise. The EPM system plays an important role in managing various types of organizational data, from linking operational metrics to insights, and ultimately providing the organization with information that is used to formulate strategies, plans, and execution of applications and projects. With enterprise performance management systems, an organization can further drive improved performance across the organization by monitoring results against forecasts and goals and using analytics to recognize key trends and predict outcomes.

An enterprise performance management system requires initial registration of enterprises for which the EPM system will be implemented. During initial registration, one or more enterprises are registered with the EPM system and necessary configuration data is set up in the repository associated with the EPM system. This initial registration of enterprises comprises determining one or more user devices of the enterprises that will be configured to send data to the EPM system over the network. In an exemplary enterprise, one or more user device may be an IoT device, a server or an IoT gateway and may generate data in a non-standard format, which needs to be processed by the EPM system after necessary conversion by the converter framework.

In current EPM systems and like environments, wherein data from various, and disparate, connected sources is collected for integration, it is a time-taking and complex procedure to identify the various user devices and associated data type, and to subsequently route the data to appropriate converters for data conversion into a standard format that can be used to build the knowledge graphs which, for example, can be used in forensics, predictive analytics and compliance monitoring. A particular challenge that exists in current EPM systems is related to the enrichment of a knowledge graph (or a plurality of knowledge graphs), upon which the data analytics depends. The knowledge graph may be a collection of interlinked descriptions of entities, data, and relationships and the knowledge graphs links data from different sources (and in different formats) in context to provide a uniform framework for data integration, analytics and sharing. In EPM system that are currently deployed, data that is required to build this knowledge graph often exists in the enterprise systems and not at the location of the EPM system, which may be on a cloud, thereby making updation/enrichment of the knowledge graph a challenge and often the knowledge graph of the EPM system is enriched manually and involve tedious process.

A challenge also exits where new user devices that are initially not registered with the EPM system are added to the enterprise. Once the EPM system starts receiving data from the new user devices in one or more non-standard formats, the EPM system will have to, but cannot, identify the user and domain from which the data originates before the EPM system can effectively use the data for its analytical tools. Thereafter, a problem exists as to how to update the repository in real-time by adding new user device information so as to enhance processing of future iterations of data arising out of the new user devices.

Accordingly, the present disclosure provides a system and a method for automatically routing data to a suitable converter in an EPM system, thereby making the EPM system more efficient and robust.

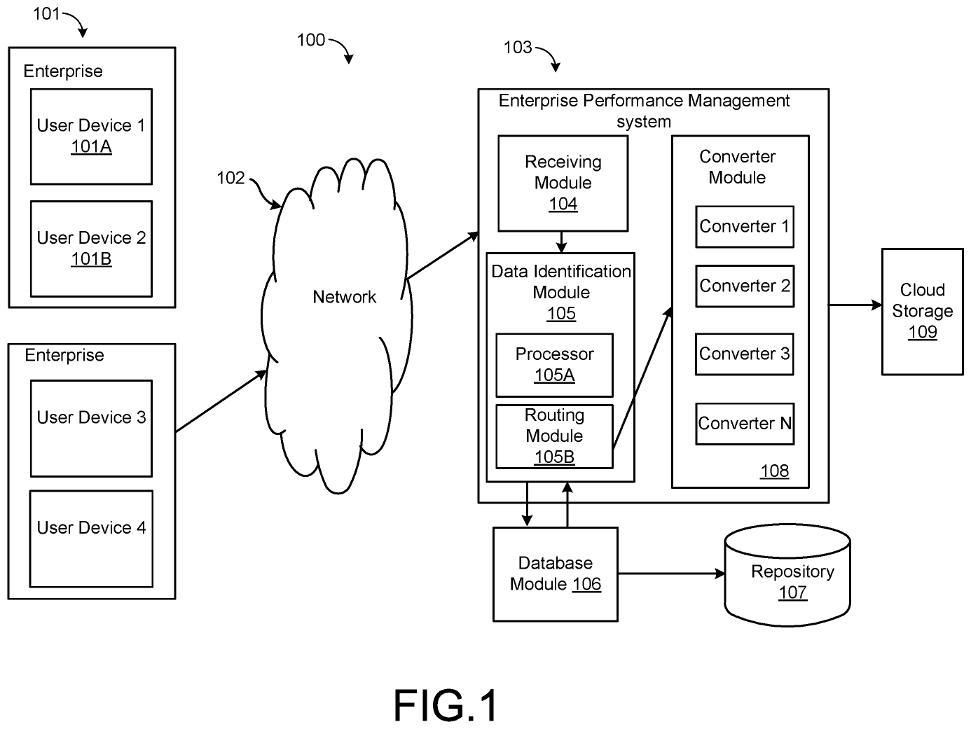

FIG. 1 illustrates an exemplary system 100 according to an aspect of the present disclosure. The system comprises one or more enterprises 101 having one or more user devices 101a, 101b which generate data to be used by EPM system 103. One or more enterprises 101 are connected to the EPM system 103 through a network 102.

In some embodiments, the network 102 may be a public network (e.g., the Internet), a private network (e.g., an internal localized, or closed-off network between particular devices). In some other embodiments, the network 102 may be a hybrid network (e.g., a network enabling internal communications between particular connected devices and external communications with other devices). In various embodiments, the network 102 may include one or more base station(s), relay(s), router(s), switch(es), routing station(s), and/or the like.

In one embodiment, the EPM system 103 may be configured as a cloud-based system. In a cloud-based system, application programs, file storage and other computing resources are remotely provided over the Internet through a browser. A web browser may be capable of running a program that is embedded in the browser (e.g., applets), which can further be application programming interfaces to more other applications running remotely on servers. In a cloud-based system a user can create, update and delete files on the remote server via the application program running remotely, which is accessed through the browser. In various embodiments, one or more devices of the enterprise may be communicatively coupled to transmit data to and/or receive data from one another over the network. Such configuration(s) include, without limitation, a wired or wireless Personal Area Network (PAN), a Cloud network, Local Area Network (LAN), Metropolitan Area Network (MAN), Wide Area Network (WAN), and/or the like.

In an embodiment, an enterprise 101 may be a business entity, an organization, a data warehouse, or any separate, standalone entities. Each enterprise 101 is linked with one or more user devices 101a, 101b from which the data originates and is configured to be transmitted over the communication network to EPM framework. The user devices 101a, 101b may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein.

One or more enterprises 101 are registered with EPM system 103 through a registration process. The registration process includes setting up a user account with EPM. In an embodiment, for devices, which are designated to send the data to the EPM system, a user account may be created with specific login credentials. The user account may identify the user's name, devices associated with the user. In an embodiment, the user account details may also specify the data type or file type which will be uploaded onto the EPM system. EPM registered users can use their identity domain credentials to connect to EPM system.

The user devices 101a, 101b of an enterprise may generate data in a non-standard format, which needs to be processed by the EPM system 103 after necessary conversion by converter modules. A non-standard format may include file with extensions for example .doc, .xls, .csv, .pdf, and other additional data type such as image file or a message stream. In a further embodiment, the user device may send or upload individual data separately or upload multiple files together.

The data which are converted and stored on EPM system may be termed as EPM files and EPM files are saved with specific file extensions, for example, .epm, .slm or .bpf, depending on the software used. The file format may vary between different EPM products, but it serves the purpose of storing various data for analytics. In a further embodiment, one or more EPM files may include budget files, forecast files, data integration file, analysis files.

In one aspect, the EPM system 103 comprises a receiving module 104, a data identification module 105, and a converter module 108. Further, the data identification module 105 is coupled to a database module 106 and said database module 106 is further coupled to a repository 107. Also, a cloud storage 109 is provided which is coupled to the EPM system 103. The files stored in the cloud storage 109 may be retrieved and the information utilized for performing the data analytics.

In an embodiment, one or more modules of the EPM system 103 may be implemented using one or more processor(s) or said modules may be hardware, computer software, or any combination thereof. The EPM system 103 receives the data from one or more user devices 101a, 101b. The embodiments of the present disclosure include two aspects, wherein in one aspect, the user device from which the data is received in a known device and in another aspect, the user device from which the data is received is an unknown device. The system according to the present invention is configured to process data from the known device and unknown devices.

The exemplary system for processing the data from a registered user device is discussed herewith.

In an embodiment, the data from one or more user devices 101a, 101b is received by the receiving module 104 and is provided to the data identification module 105 for further processing and routing. The user devices 101a, 101b may be a registered device with the EPM system.

The data identification module 105 receives the data and process the data to identify one or more information associated with the incoming data. In an embodiment, the data identification module 105 includes a data processor 105a which processes the received data to identify the user device through the header data or using block of data being stored or transmitted as part of data. As part of processing, the data processor 105a identifies the data type of the data received from the user device. The data processor 105a is configured to process the incoming file, messages and identify one or more information associated with the incoming file. In an example, one or more information may include source device identifier, sign-in details, user account associated with received file, file type received based on file extensions, the size of the file/data.

The identification module 105 is operationally coupled to the database module 106. Based on information parsed from the received data, the identification module 105 queries the database module 106, to determine if the user device is a registered device. The identification module 105 may also be configured to directly query the repository 107 to determine if the user device is a registered device.

In an embodiment, the data files sent to the database module 106 includes header information and/or other data block information associated with the user device and user device identification data. Based on the query from the data identification module 105, the database module 106 determines that the user device is a registered device. In an embodiment, the database module 106 is operationally coupled to the repository 107 and the database module 106 may query the repository to retrieve information associated with the user device and the enterprise, so as to decide whether the user device is a registered device and send the information to data identification module 105.

The information associated with the user device along with configuration files are provided to the data identification module 105, based on which the data identification module further processes the data received from the user device 101a, 101b.

In an embodiment, the configuration files received by the data identification module 105 from the database module 106 includes datatype information, converter information and routing protocols.

In an embodiment, the data identification module 105 is operationally coupled to the converter module 108 to route the data for conversion. In an embodiment, the data identification module 105 includes a routing module 105b for routing data to converter module.

The data identification module 105, based on datatype information, converter information and routing protocols retrieved from database module 106, routes the data through the routing module 105b to the converter module 108. In an embodiment, the data files sent to the routing module 105b includes user device's data, datatype information, converter information and routing protocols. The converter module 108 receives the data from the routing module 105b and converts the received data into an EPM file.

Subsequently, the converted data is stored in the cloud storage 109 for further processing and analysis.

The embodiments of the present disclosure enable automatic identification of user devices which are registered with the EPM system and accordingly, the data files received from these registered user devices are converted by the converter module based on predetermined configurations associated with registered user devices.

In an alternative embodiment, the present disclosure provides a system for processing the data from an unregistered user device, which is discussed herewith.

In an embodiment, the data from one or more user devices 101a, 101b is received by the receiving module 104 and is provided to the data identification module 105 for further processing and routing. The user devices 101a, 101b may be an unregistered device with the EPM system.

The data identification module 105 receives the data and process the data to identify one or more information associated with the incoming data. In an embodiment, the data identification module 105 includes a data processor 105a which processes the received data to identify the user device through the header data or using block of data being stored or transmitted as part of data. As part of processing, the data processor 105a identifies the data type of the data received from the user device. The data processor 105a is configured to process the incoming file, messages and identify one or more information associated with the incoming file. In an example, one or more information may include enterprise information/identifier, source device identifier, sign-in details, user account associated with received file, file type received based on file extensions, the size of the file/data.

The identification module 105 is operationally coupled to the database module 106. Based on parsed information from the received data, the identification module 105 queries the database module 106, to determine if the user device is a registered device.

The identification module 105 may also be configured to directly query the repository 107 to determine if the user device is a registered device. In an embodiment, the data files sent to the database module 106 or repository 107 includes header information and/or other data block information associated with the user device's received data and user device identification data.

In an embodiment, the database module 106 stores configuration details of enterprises and user devices which are registered with EPM system. The configuration details include the list of enterprises, list of user devices belonging to one or more registered enterprises, the data type in respect of one or more user devices, routing rules and settings. In an embodiment, the routing rules may include predefined rules for routing the incoming data from a particular user device to a specific converter. Further, the settings configuration may include scheduling of routing, and updating of routing protocols.

Based on the query from the data identification module 105, the database module 106 determines that the user device is an unregistered device and the information indicating the same is provided to the data identification module 105. In an embodiment, the database module 106 is operationally coupled to the repository 107 and the database module 106 may query the repository 107 to retrieve information associated with the user device and the enterprise, so as to decide whether the user device is an unregistered device and send the information to data identification module 105.

In a further embodiment, the data identification module 105 upon determination that the user device is not registered with EPM system, identifies the enterprise id from which the data originated. Further, the data identification module 105 identifies the correct converter for the received data file, by routing the data file through the converter module 108. The data from the data identification module 105 is routed to the converter module 108 through the routing module 105b to check which converter successfully coverts the data into EPM file. In an embodiment, the data from the identification module 105 can be forward to each converter separately and may receive feedback whether the data was successfully converted. Alternatively, the data can be routed through multiple converters in sequential manner and the identification module may receive feedback once a specific converter is able to convert the data into EPM file.

In an embodiment, the converter module 108 comprises one or more converters which are configured to convert the non-standard data to the standard data, also known as EPM file. The files/data which are converted and stored on EPM system may be termed as EPM files and EPM files are saved with specific file extensions, for example, .epm, .slm, or .bpf, depending on the software used. The file format may vary between different EPM products, but it serves the purpose of storing various data for analytics.

The converter module 108 is configured to receive the data for conversion and based on successful conversion, the converter module 108 provides the feedback to the data identification module 105. The data identification module 105, based on feedback from converter module 108, may identify one or more converters which were successful in converting the data file into EPM file. Subsequently, the converted data is stored in the cloud storage 109 for further processing and analysis.

In a further embodiment, the data identification module 105 updates the database module 106 to add unregistered user device and associate converter identifier. The data identification module 105 sends the information of converter file(s) which was successful in converting the data, to the database module 106. The database module 106 stores the received information on correct converter and user device information in the repository 107. In one embodiment, the EPM system 103 is coupled to a repository 107 which stores the information on the registered enterprises and its associated user/user devices. The repository 107 comprises configuration files which stores information on datatype associated with a particular user device and rules/settings are configured for routing of data from the registered user devices.

Further, the database module 106 stores the information on association of enterprises, user devices, data type, converter type and its corresponding rules, which enables the data identification module to process the incoming data from one or more added user devices.

In this way, the embodiments of the EPM system 103 enable initial identification of user devices which are unregistered with the EPM system and accordingly, the next instance of data files received from these unregistered user devices are automatically routed based on predetermined configurations associated with added unregistered user devices.

In this manner, the knowledge graph of the EPM system is enriched in real-time and a more robust system is built. As the previously unregistered user device is now added to the repository, one or more rules have been updated along with converter identifier, the next instances of data receiving from the said user device will be automatically routed to the converter module by the data identification module based on its collaboration with the database module and repository thereby enhancing the efficiency of the EPM system.

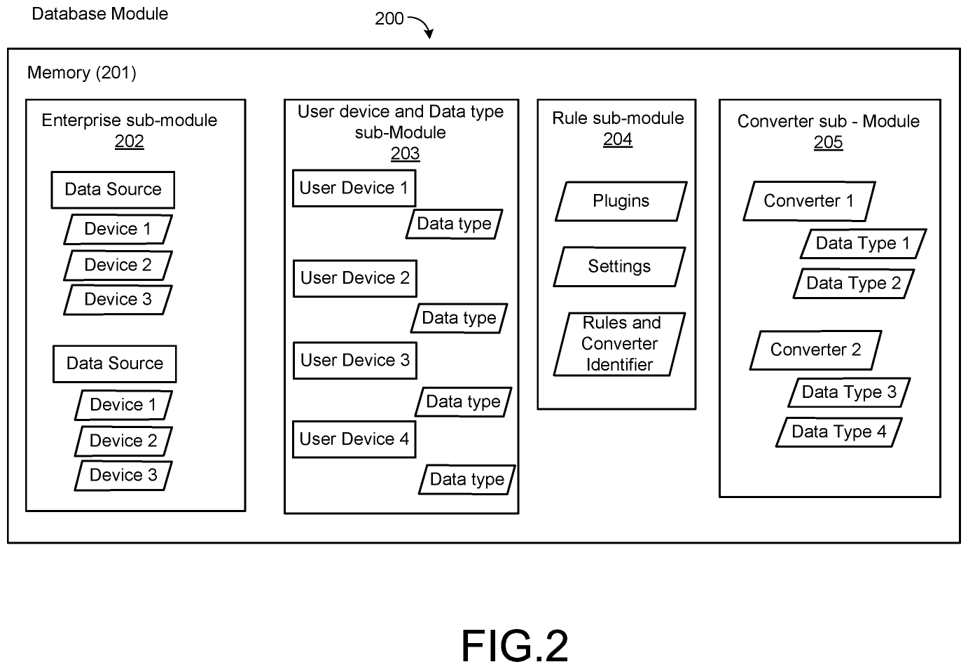

FIG. 2 illustrates an exemplary embodiment of the database module 200 of the present disclosure. The database module 200 stores configuration details of enterprises and user devices which are registered with EPM system. The configuration details include the list of enterprises, list of user devices belonging to one or more registered enterprises, the data type in respect of one or more user devices, routing rules and settings for routing the data to converters. In an embodiment, the routing rules may include predefined rules for routing the incoming data from a particular user device to a specific converter. Further, the settings configuration may include scheduling of routing, and updating of routing protocols.

The database module 200 includes a memory 201 which stores one or more sub-modules namely, an enterprise sub-module 202, a user device and data type sub-module 203, a rule sub-module 204 and a converter sub-module 205.

The memory 201 may be non-transitory and may include, for example, one or more volatile and/or non-volatile memories. In some embodiments, the memory includes or embodies an electronic storage device (e.g., a computer readable storage medium). In some embodiments, the memory is configured to store information, data, content, applications, instructions, or the like, for enabling a system to carry out various operations and/or functions in accordance with example embodiments of the present disclosure.

In an embodiment, the enterprise sub-module 202 identifies one or more enterprises which are registered with the EPM system during initial registration process. One or more information identifying a particular enterprise may include domain name and domain ID of a particular enterprise. Further, the enterprise sub-module 202 also includes a list of user/user devices which belongs to the one or more enterprises. Information associated with user devices may include name of the device, device's IP address, file type generated by the devices, login credentials of user devices etc. In an embodiment, the enterprise sub-module 202 associates the user devices to the enterprise so that the information can be retrieved by the data identification module.

In a further embodiment, the user device and data type sub-module 203 provides the association of one or user device with a data type. The data type of files generated by one or more user devices is established and association is created in the data type sub-module 203. In an exemplary embodiment, one or more non-standard format generated by the user device may include file with extensions for example .doc, .xls, .csv, .ppt, .pdf, and other additional data type such as image file, message stream.

Further, the rule sub-module 204 includes one or more rules to be adopted to process the received data from a user device. One or more rules associated with the user device may include routing protocols, scheduling data conversion, rules associated with processing of single file or multiple files for a specific user device. The rule sub-module 204 may additionally include, for example, plugin information, which may be required to be used for a particular user device, and settings related to enabling and disabling of one or more features related to routing protocols.

In a further embodiment, the converter sub-module 205 associates one or more data type to one or more converters for data conversion. In an exemplary embodiment, a specific data type may be converted by one or more converters. In a further embodiment, one or more user devices may be associated to one or more converters based on their data type.

The database module 200 stores data indicating linking of various parameters such enterprise, user device, converters and the data type. The database module 200 is coupled to the repository to fetch the stored information on enterprise data, user device data, and converters files. The database module 200 through various sub-modules such as the enterprise sub-module 202, the user device and data type sub-module 203, the rule sub-module 204 and the converter sub-module 205 provides the link between the enterprises and their associated user device, the data type associated with each user device, and rule and protocol associated with each user device, and converters associated with different data types.

The database module 200 is accessed by the data identification module to retrieve the information based on association of enterprises, user devices, data type and its corresponding rules, which enables the data identification module to process the incoming data from one or more user devices.

In a further embodiment, the database module 200 is updated from time to time based on information stored in the repository, so as to provide the data identification module with updated association between enterprises, user devices, data type and its corresponding rules.

In an embodiment, the database module 200 can be an integral part of the EPM system 103. In an alternative embodiment, the database module 200 can be remotely located which can be accessed by the EPM system 103 through a network. In yet another alternative embodiment, the database module 200 and repository can be an integral part of the EPM system 103.

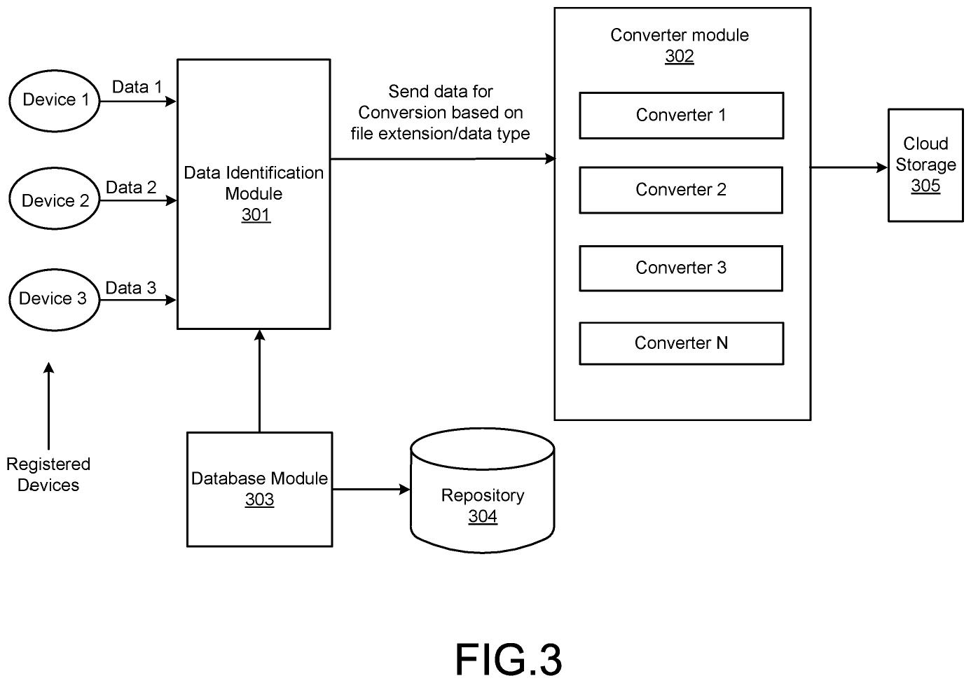

FIG. 3 illustrates an exemplary embodiment for converter selection for registered user devices in accordance with the present invention.

In an embodiment, the data from one or more user devices is received by the data identification module 301 for further processing, and routing. The user devices may be a registered device with the EPM system. As the user device is already registered with the EPM system, the data type which are received from one or more devices are already known and the identifiers for data types are already stored in the database module. The devices may generate data in a non-standard format, which needs to be processed by the EPM system after necessary conversion by converter module 302. A non-standard format may include file with extensions for example .doc, .xls, .csv, .pdf, and other additional data type such as image file or a message stream. The device may send or upload individual data separately or upload multiple files together.

The identification module 301 receives data from one or more devices pertaining to one or more registered enterprises. In an embodiment, the data identification module 301 receives the data and identifies the user device and the enterprise from which the data originates. The data identification module 301 processes the incoming file, messages and identifies data associated with the incoming file. In an example, the data may include source device identifier, sign-in details, user account associated with received file, file type received based on file extensions, the size of the file/data.

The identification module 301, upon receiving the data, queries the database module 303, to determine if the user device is a registered device. In an alternative embodiment, the identification module 301 can directly query the repository 304 to retrieve one or more information relating to identified user device. In an embodiment, the data files sent to the database module 303 for querying includes header information and/or other data block information associated with the user device. Based on the query from the data identification module 301, the database module 303 determines that the user device is a registered device and the information associated with the user device along with configuration files are provided to the data identification module 301, based on which the data identification module 301 processes the data received from the user device. In an embodiment, the configuration files received from the database module 303 includes datatype information, converter information and routing protocols.

The data identification module 301, based on datatype information, converter information and routing protocols retrieved from database module 303, routes the data to the converter module 302. In an embodiment, the data files sent to the converter module 302 may include data for conversion, datatype information, converter information and routing protocols.

The converter module 302 receives the data from the data identification module 301 and converts the received data into an EPM file. The converter module 302 comprises one or more converters which are configured to convert the non-standard data to the standard data, such as EPM file. The files/data which are converted and stored on EPM system may be termed as EPM files which are saved in a cloud storage 305 with specific file extensions, for example, .epm, .slm, or .bpf, depending on the software used. The file format may vary between different EPM products, but it serves the purpose of storing various data for analytics.

The exemplary converter selection as explained in FIG. 3 enables automatic identification of user devices which are registered with the EPM system and accordingly, the data files received from these registered user devices are converted by the converter module based on predetermined configurations associated with registered user devices.

In an embodiment, the identification module may receive data from one or more user devices which may pertain to one or more unregistered devices with EPM system. In general, one or more devices may be added to a registered enterprise, however, said user devices may be an unregistered device with EPM system. Therefore, when the EPM system receives data from these unregistered user devices it may not have pre-configuration details with respect to the unregistered devices and hence, the data received from these unregistered devices will have to be processed before the data is sent for conversion.

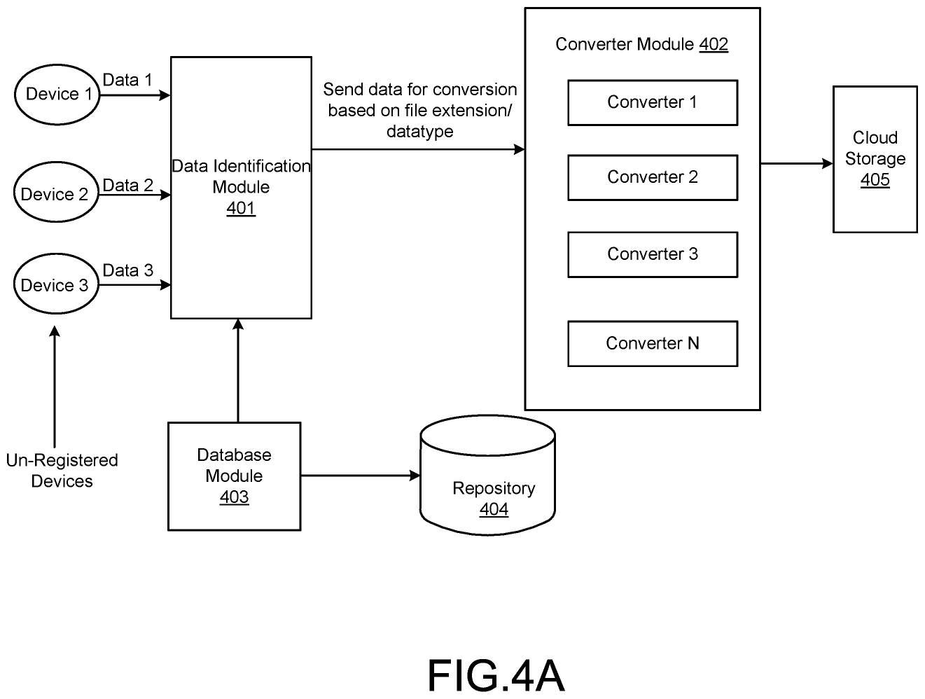

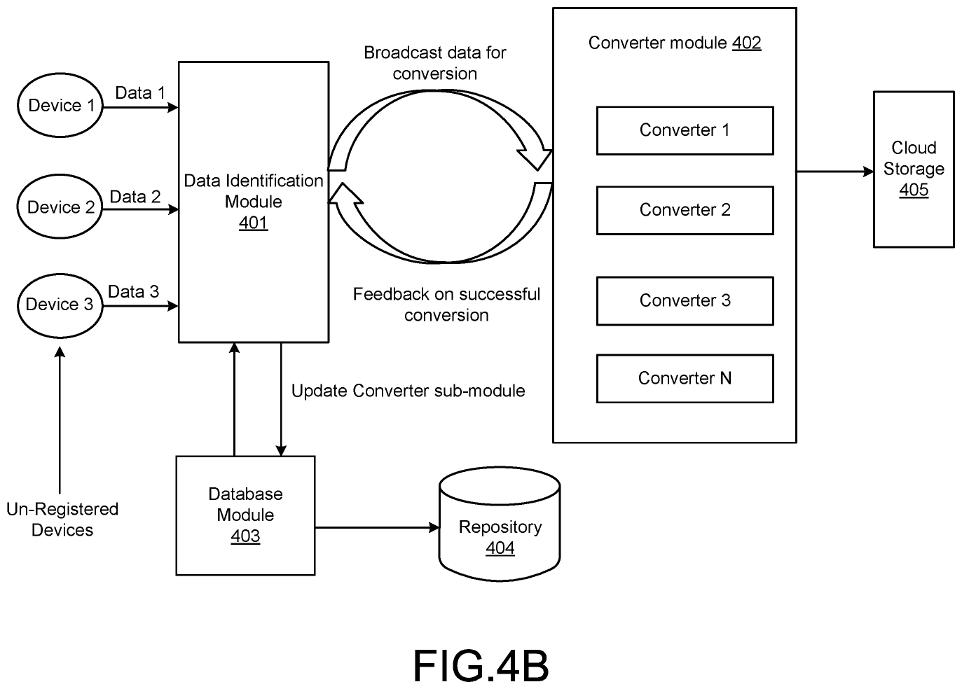

FIG. 4a and FIG. 4b illustrates exemplary embodiments of the present inventions when the user devices which sends data to the EPM system is an unregistered device.

FIG. 4a illustrates an exemplary embodiment for converter selection for an unregistered user device in accordance with one aspect of the present invention.

The data identification module 401 receives the data and identifies the user device and the enterprise from which the data originated. The data identification module 401 processes the incoming file, messages and identify one or more information associated with the incoming file. In an example, one or more information may include source device Identifier, file type received based on file extensions, the size of the file/data. Further, the data identification module identifies the enterprise domain from which the data originated.

The identification module 401, upon receiving the data, queries the database module 403, to determine if the user device is a registered device. In an embodiment, the identification module 401 can directly query the repository 404 to retrieve one or more information relating to identified user device. In an embodiment, the data files sent to the database module 403 for querying includes header information and/or other data block information associated with the user device. Based on the query from the data identification module, the database module 403 determines that the user device is an unregistered device. Based on the determination that the user device cannot be identified using the enterprise sub-module in the database module, the information indicating that the user device is an unregistered device is sent to the data identification module 401.

The data identification module 401 processes the incoming data and identifies the data type of the data sent by one or more unregistered user devices. Based on determination of data type, the data identification module 401 in collaboration with the database module 403 identifies the correct converter for the received file datatype. The database module 403 through converter sub-module determine one or more correct converter for the identified datatype and indicates the same to the data identification module 401. The data identification module 401 based on determination of correct converter based on received file datatype, routes the data file to the converter module 402. In an embodiment, the data files sent to the converter module 302 may include data for conversion, datatype information, converter information and routing protocols.

The converter module 402 receives the data from the data identification module 401 and converts the received data into an EPM file. The converter module 402 comprises one or more converters which are configured to convert the non-standard data to the standard data, such as EPM file. Based on identification of correct converter by the data identification module 401, the files/data are sent to identified converter for data conversion and the converter data are stored on a cloud storage 405 with specific file extensions, for example, .epm, .slm, or .bpf, depending on the software used.

FIG. 4b illustrates an alternate exemplary embodiment for converter selection for an unregistered user device in accordance with another aspect of the present invention.

The data identification module 401 receives the data and identifies the user device and the enterprise from which the data originated. The data identification module 401 processes the incoming file, messages and identify one or more information associated with the incoming file. In an example, one or more information may include source device Identifier, file type received based on file extensions, the size of the file/data. Further, the data identification module identifies the enterprise domain from which the data originated.

The identification module 401, upon receiving the data, queries the database module 403, to determine if the user device is a registered device. In an embodiment, the identification module 401 can directly query the repository 404 to retrieve one or more information relating to identified user device. In an embodiment, the data files sent to the database module 403 for querying includes header information and/or other data block information associated with the user device. Based on the query from the data identification module, the database module 403 determines that the user device is an unregistered device. Based on the determination that the user device cannot be identified using the enterprise sub-module in the database module, the information indicating that the user device is an unregistered device is sent to the data identification module 401.

The data identification module 401 processes the incoming data and identifies the data type of the data sent by one or more unregistered user devices. Based on determination of data type, the data identification module 401 queries the database module 403 to identify a converter for the identified data type.

In an embodiment, the database module 403, after verifying the converter sub-module, may indicate to the data identification module 401 that a correct converter cannot be determined based on identified datatype. Based on the determination that a correct converter is not identified in the database module, the data identification module 401 may broadcast the data file to conversion module 402 for data conversion. The data identification module 401 routes the data to the converter module 402 to check which converter successfully coverts the data into EPM file.

In an embodiment, the data from the identification module 401 can be forward to each converter separately and may receive feedback whether the data was successfully converted.

In an alternative embodiment, the data can be routed through multiple converters in sequential manner and the identification module may receive feedback once a specific converter is able to convert the data into EPM file.

The converter module 402 receives the data for conversion and based on successful conversion, the converter module 402 provides the feedback to the data identification module 401. The data identification module 401, based on feedback from converter module 402, may identify one or more converters which were successful in converting the data file into EPM file.

Further, the data identification module 401 updates the database module 403 to add unregistered user device and associate converter identifier. In this step, the data identification module sends the information of converter file(s) which was successful in converting the data, to the database module 403 for updating the converter submodule. In an embodiment, the data identification module provides information to the database module 403 on enterprise domain to which the unregistered device belongs. The database module 403 in operation with repository 404 updates the enterprise sub-module to add the unregistered device and associate converter identifier with the added unregistered user device. Also, based on feedback received from data identification module 401, the converter sub module of the database module 403 associates the identified one or more converters to the specific user device.

The above exemplary embodiment explained in FIG. 4a and FIG. 4b enables initial identification of user devices which are unregistered with the EPM system and accordingly, the next instance of data files received from these unregistered user devices are automatically routed based on predetermined configurations associated with added unregistered user devices.

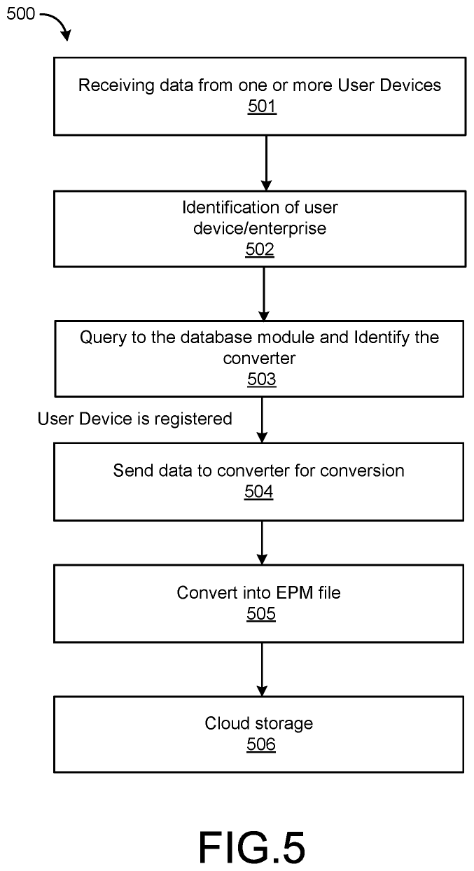

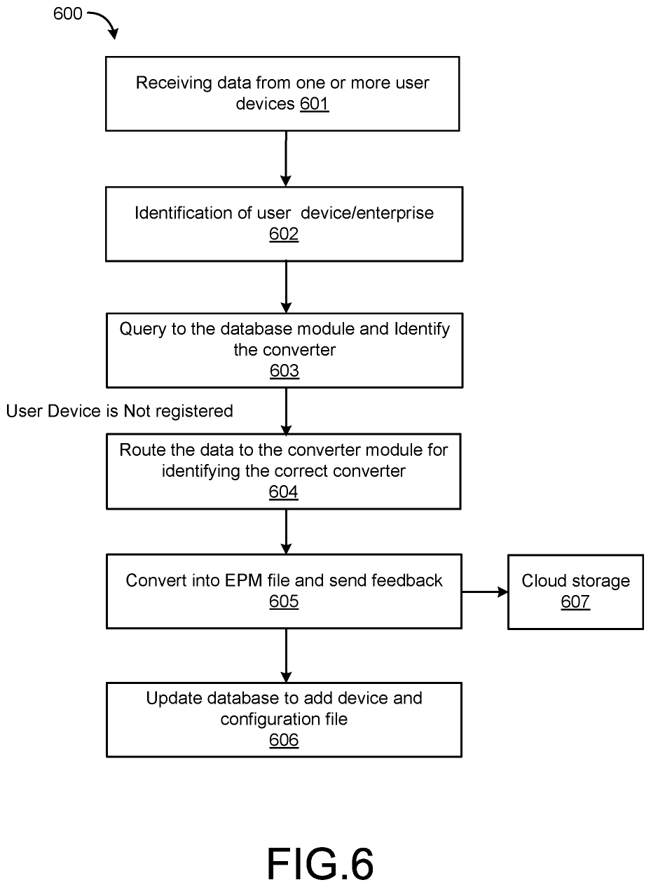

FIG. 5 and FIG. 6 illustrates method in accordance with the embodiments of the present disclosure. The embodiments of the claimed method in FIG. 5 and FIG. 6 includes two aspects, wherein in one aspect, the user device from which the data is received in a known device and in another aspect, the user device from which the data is received is an unknown device. The method of the present disclosure provides steps involved in processing data from the known device and unknown devices.

In FIG. 5, an exemplary method is discussed herewith, when the received data is from a registered user device.

The method begins at step 501 at which the identification module receives data from one or more user devices. The data is received from one or more user devices which pertains to one or more registered enterprises. The user devices from which the data is received may be registered device with the EPM system.

At step 502, the data identification module receives the data and identifies the user device and the enterprise from which the data originates. The data identification module processes the incoming file, messages and identifies data associated with the incoming file. In an example, the data may include source device identifier, sign-in details, user account associated with received file, file type received based on file extensions, the size of the file/data.

In step 503, upon receiving the data, the identification module queries the database module, to determine if the user device is a registered device. In an embodiment, the identification module can directly query the repository to retrieve one or more information relating to identified user device. In an embodiment, the data files sent to the database module includes header information and/or other data block information associated with the user device. Based on the query from the data identification module, the database module determines that the user device is a registered device and the information associated with the user device along with configuration files are provided to the data identification module, based on which the data identification module further processes the data received from the user device. In an embodiment, the configuration files received from the database module includes datatype information, converter information and routing protocols.

In step 504, the data identification module, based on datatype information, converter information and routing protocols retrieved from database module, routes the data to the converter module through routing module. In an embodiment, the data files sent to the routing module includes datatype information, converter information and routing protocols.

In step 505, the converter module receives the data from the routing module and converts the received data into an EPM file.

Further, in step 506, the converted data is stored in the cloud storage for further processing and analysis.

The above method steps enable automatic identification of user devices which are registered with the EPM system and accordingly, the data files received from these registered user devices are converted by the converter module based on predetermined configurations associated with registered user devices.

In FIG. 6, An exemplary method is discussed herewith, when the received data is from an unregistered user device.

The method begins at step 601 at which the identification module receives data from one or more user devices. The data is received from one or more user devices which pertains to one or more registered enterprises. The user devices from which the data is received may be an unregistered device with the EPM system.

At step 602, the data identification module receives the data and identifies the user device and the enterprise from which the data originated. The data identification module processes the incoming file, messages and identify one or more information associated with the incoming file. In an example, one or more information may include source device Identifier, file type received based on file extensions, the size of the file/data. Further, the data identification module identifies the enterprise domain from which the data originated.

In step 603, upon receiving the data, the identification module queries the database module, to determine if the user device is a registered device. In an embodiment, the identification module can directly query the repository to retrieve one or more information relating to identified user device. In an embodiment, the data files sent to the database module for querying includes header information and/or other data block information associated with the user device. Based on the query from the data identification module, the database module determines that the user device is an unregistered device. Based on the determination that the user device cannot be identified using the enterprise sub-module in the database module, the information indicating that the user device is an unregistered device is sent to the data identification module.

In step 604, the data identification module identifies the correct converter for the received data file, by routing the data file through the converter module. The data from the data identification module is routed to the converter module to check which converter successfully coverts the data into EPM file. In an embodiment, the data from the identification module can be forward to each converter separately and may receive feedback whether the data was successfully converted. Alternatively, the data can be routed through multiple converters in sequential manner and the identification module may receive feedback once a specific converter is able to convert the data into EPM file.

In Step 605, the converter module receives the data for conversion and based on successful conversion, the converter module provides the feedback to the data identification module. The data identification module, based on feedback from converter module, may identify one or more converters which were successful in converting the data file into EPM file.

Further, in step 606, the data identification module updates the database module to add unregistered user device and associate converter identifier. In this step, the data identification module sends the information of converter file(s) which was successful in converting the data, to the database module for updating the converter submodule. In an embodiment, the data identification module provides information to the database module on enterprise domain to which the unregistered device belongs. The database module in operation with repository updates the enterprise sub-module to add the unregistered device and associate converter identifier with the added unregistered user device. Also, based on feedback received from data identification module, the converter sub module of the database module associates the identified one or more converters to the specific user device. In additional embodiment, converter sub module is updated to map one or more converters to the data types generated by the added unregistered user device.

In step 607, the converted data is stored in the cloud storage for further processing and analysis.

The above method steps enable initial identification of user devices which are unregistered with the EPM system and accordingly, the next instance of data files received from these unregistered user devices are automatically routed based on predetermined configurations associated with added unregistered user devices.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment). The present disclosure intends to include specific reference to all combinations and sub combinations of physically compatible features, components, apparatuses, and processes described herein. As used herein, the term “or” is used in both the alternative and conjunctive sense, unless otherwise indicated. Use of any such aforementioned terms, or similarly interchangeable terms, should not be taken to limit the spirit and scope of embodiments of the present disclosure. As used in the specification and the appended claims. The singular form of “a,” “an,” and “the” include plural references unless otherwise stated. The terms “includes” and/or “including,” when used in the specification, specify the presence of stated features, elements, and/or components, and/or groups thereof.

In an embodiment, the functional units have been labeled as modules, in order to more particularly emphasize their implementation independence. For example, a module may be implemented as a hardware or a software by various types of processors. A module of executable code may, for instance, comprise one or more physical or logical blocks of computer instructions, which may, for instance, be organized as an object, procedure, or function. Nevertheless, the executables of a module need not be physically located together, but may comprise disparate instructions stored in different locations which, when joined logically together, comprise the module and achieve the stated purpose for the module.

In an embodiment, the functional units have been labeled as modules, in order to more particularly emphasize their implementation independence. For example, a module may be implemented as a hardware or a software by various types of processors. A module of executable code may, for instance, comprise one or more physical or logical blocks of computer instructions, which may, for instance, be organized as an object, procedure, or function. Nevertheless, the executables of a module need not be physically located together, but may comprise disparate instructions stored in different locations which, when joined logically together, comprise the module and achieve the stated purpose for the module.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

Processor may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor includes hardware, software, firmware, and/or a combination thereof that performs one or more operations described herein.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments, a storage system or other management entity within the artificial intelligence and machine learning infrastructure may also implement automated training with continuous learning based on new data.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A system for processing data received from a plurality of user devices in an enterprise management system, comprising:
a processor;
a memory storing program instructions which, when executed by the processor, causes the processor to:
store, in a database, one or more configuration files and information related to the plurality of user devices;
receive, via a communication network, data from at least one user device from the plurality of user devices;
identify an enterprise, a user device, and datatype of the received data;
query the database to identify if the user device is a registered device or an unregistered device;
receive, based on the query, information indicating if the user device is the registered device or the unregistered device; wherein
when the user device is the registered device, the processor is configured to route the data for data conversion based on at least one configuration file of the one or more configuration files, wherein the at least one configuration file is associated with the registered device; and
when the user device is identified to be the unregistered device, the process is further configured to:
automatically route the data for data conversion;
identify at least one converter of one or more converters for the data type of the received data;
update the database to add the unregistered device and configuration files associated with the added registered device; and
enrich one or more knowledge graphs associated with the enterprise based on the updated database.

2. The system of claim 1, wherein the processor is configured to:
update the database to map the at least one converter of the one or more converters for the added unregistered device.

3. The system of claim 1, wherein the processor is configured to:
update the database to map the added unregistered device to one or more enterprises.

4. The system of claim 1, wherein the database includes enterprise identifiers, user device and data type identifiers, rule identifiers and converter identifier.

5. The system of claim 1, wherein the enterprise management system is implemented on a cloud network.

6. The system of claim 1, wherein the processor comprises a plurality of modules coupled to each other and operates fully independent of each other.

7. The system of claim 1, wherein the database is a part of the enterprise management system.

8. The system of claim 1, wherein the database is remotely located and accessed by the enterprise management system.

9. A method for processing data received from a plurality of user devices in an enterprise management system, comprising:
storing in a database, one or more configuration files and information related to the plurality of user devices;
receiving, via a communication network, data from at least one user device from the plurality of user devices;
identifying an enterprise, a user device, and datatype of the received data;
querying the database to identify if the user device is a registered device or an unregistered device;
receiving, based on the query, information from the database indicating if the user device is the registered device or the unregistered device; wherein
when the user device is the registered device, routing the data to a converter for data conversion based on at least one configuration file of the one or more configuration files, wherein the at least one configuration file is associated with the registered device; and
when the user device is determined to be the unregistered device, the data identification module:
automatically route the data for data conversion;
identify at least one converter of the one or more converters for the data type of the received data;
update the database to add the unregistered device and configuration files associated with the added registered device; and
enrich one or more knowledge graphs associated with the enterprise based on the updated database.

10. The method of claim 9, comprising:
mapping the at least one converter of the one or more converters for the newly added unregistered device.

11. The method of claim 9, comprising:
mapping the unregistered device to one or more registered enterprises; and
updating one or more routing rules for the unregistered user device.

12. The method of claim 9, wherein identifying the at least one converter for a data type of the unregistered device further comprises:
routing the data to the one or more converters for the data conversion;
receiving the information from the one or more converters indicating a converter file which is successful in converting the data; and
providing the information to the database for updating the configuration files associated with the added registered device.

13. The method of claim 9, wherein identifying the at least one converter for a data type of the registered device further comprises:
querying the database to identify the at least one converter; and
receiving the identified converter information for the data conversion.

14. The method of claim 9, wherein the database includes enterprise identifiers, user device and data type identifiers, rule identifiers and converter identifier.

15. The method of claim 9, comprising:
remotely accessing the database by the enterprise management system.

16. A non-transitory computer-readable storage medium storing program instructions for processing data received from a plurality of user devices in an enterprise management system, when executed, perform the steps of:
storing in a database, one or more configuration files and information related to the plurality of user devices;
receiving, via a communication network, data from at least one user device from the plurality of user devices;
identifying an enterprise, a user device, and datatype of the received data;
querying the database to identify if the user device is a registered device or an unregistered device;
receiving, based on the query, information from the database indicating if the user device is the registered device or the unregistered device; wherein
when the user device is the registered device, routing the data to a converter for data conversion based on at least one configuration file of the one or more configuration files, wherein the at least one configuration file is associated with the registered device; and
when the user device is determined to be the unregistered, the data identification module:
automatically route the data for data conversion;
identify at least one converter of the one or more converters for the data type of the received data;
update the database to add the unregistered device and configuration files associated with the added registered device; and
enrich one or more knowledge graphs associated with the enterprise based on the updated database.

17. The non-transitory computer-readable storage medium of claim 16, comprising program instructions to perform the steps of:
mapping the at least one converter of the one or more converters for the newly added unregistered device.

18. The non-transitory computer-readable storage medium of claim 16, comprising program instructions to perform the steps of:
mapping the unregistered device to one or more registered enterprises; and
updating one or more routing rules for the unregistered user device.

19. The non-transitory computer-readable storage medium of claim 16, wherein in identifying converter for a data type of the unregistered user device, comprising program instructions to perform the steps of:
routing the data to the one or more converters for the data conversion;
receiving the information from the one or more converters indicating a converter file which is successful in converting the data; and
providing the information to the database for updating the configuration files associated with the added registered device.

20. The non-transitory computer-readable storage medium of claim 16, wherein in identifying the at least one converter for a data type of the registered device, comprising program instructions to perform the steps of:
querying the database to identify the at least one converter; and
receiving the identified converter information for the data conversion.
